(19) United States
(12) Patent Application Publication
(10) Pub. No.: US 2010/0213641 A1
(43) Pub. Date: Aug. 26, 2010

(54) Method for Manufacturing a Material with a Multispectral Smoke Screening

(76) Inventors: Kuo-Hui Wu, Tahsi (TW); Pao-Hui Chen, Bade City (TW); Yann-Jang Gung, Longtan Shiang (TW); Wei-Che Hung, Tahsi (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/390,543

(22) Filed: Feb. 23, 2009

(51) Int. Cl. C08J 5/04; B29C 35/02

(52) U.S. Cl. 264/404; 264/331.11

(57) ABSTRACT

A method for manufacturing a material with a multispectral smoke screening, that is, to mix the composite materials of carbon fiber and graphite, carbon fiber and bamboo-charcoal, carbon fiber and carbon black respectively with epoxy resin to produce an absorbing film which dimensions are 15 cm×15 cm×0.2 cm and can absorbs millimeter-wave (8 mm) and infrared wave (3-5 and 8-12 μm). The film can be a smoke material of the M56 turbo smoke generator to resist the millimeter-wave and infrared wave.

### BACKGROUND OF THE INVENTION

1. Field of the Invention

The present invention generally relates to a technical field of a material, more particularly to a smoke material with the function of a millimeter-wave and infrared wave resistance and made of carbon fiber, graphite, bamboo-charcoal, carbon black, and epoxy resin.

2. Description of the Prior Art

Traditionally, the shading effect of fog oil can only function in the range of visible light to near infrared wave. So that a smoke system that sprays carbon fiber material is not developed yet.

### SUMMARY OF THE INVENTION

Presently, a smoke agent with the function of an infrared wave and millimeter-wave resistance is still not existed.

The present invention provides a method for manufacturing a material with a multispectral smoke screening, that is, to mix the composite materials of carbon fiber and graphite, carbon fiber and bamboo-charcoal, carbon fiber and carbon black respectively with epoxy resin to produce an absorbing film which dimensions are 15 cm×15 cm×0.2 cm and can absorbs millimeter-wave (8 mm) and infrared wave (3-5 and 8-12 μm). The film can be a smoke material of the M56 turbo smoke generator to resist the millimeter-wave and infrared wave.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1a to FIG. 1m are the Scanning Electron Microscope (SEM) illustration of the materials used in the invention;

FIG. 2 is a chart of the mid infrared (3 to 5 μm) thermographies temperature variations of the composite films of graphite, bamboo-charcoal and carbon black respectively mixing with 3-mm carbon fiber and polyethylene in each different weight ratio;

FIG. 3 is a chart of the far infrared (8 to 12 μm) thermographies temperature variations of the composite films of the graphite, bamboo-charcoal and carbon black respectively mixing with 3-mm carbon fiber and polyethylene in each different weight ratio;

FIG. 4 is a comparison chart of the infrared transmissions of the 3-mm carbon fiber, graphite, bamboo-charcoal, and carbon black under the same concentration (0.002 g/cm³);

FIG. 5 is a comparison chart of the infrared transmission of the graphite, 3-mm carbon fiber and composite films of mixing the graphite with the 3-mm carbon fiber according to different weight ratios;

FIG. 6 is a comparison chart of the infrared transmission of the bamboo-charcoal, 3-mm carbon fiber and composite films of mixing the bamboo-charcoal with the 3-mm carbon fiber according to different weight ratios;

FIG. 7 is a comparison chart of the infrared transmission of the carbon black, 3-mm carbon fiber and composite films of mixing the carbon black with the 3-mm carbon fiber according to different weight ratios;

FIG. 8 is a variation chart showing the reflection losses of 3-mm carbon fiber and under different mixing ratios and concentrations of the graphite with 3-mm carbon fiber;

FIG. 9 is a variation chart showing the reflection losses of bamboo-charcoal and under different mixing ratios and concentrations of the bamboo-charcoal with 3-mm carbon fiber; and

FIG. 10 is a variation chart showing the reflection losses of carbon black and under different mixing ratios and concentrations of the carbon black with 3-mm carbon fiber

### DETAILED DESCRIPTION OF THE INVENTION

Following preferred embodiments and figures will be described in detail so as to achieve aforesaid object.

1.1 Preparation of Infrared Rays Test Films: 3-mm carbon fiber is mixed with graphite, bamboo-charcoal and carbon black respectively in the ratio of 2:1, 1:1 and 1:2. Each group that is consist of the 3-mm carbon fiber with the graphite, the 3-mm carbon fiber with the bamboo-charcoal and the 3-mm carbon fiber with the carbon black then mix with polyethylene (PE) respectively so as to obtain three groups of mixed materials, and make the concentrations of each groups of the mixed material in 0.002 g/cm³, 0.004 g/cm³, 0.01 g/cm³, and 0.02 g/cm³. Thus, the materials are put into a DC mixer for mixing two hours in order to completely mixing the materials. The mixed materials are moved into a steel mold with the dimensions of 15.2 cm×15.2 cm×1 mm (=23.1 cm³). Each mixed material is compressed by an electrothermal compression forming machine and under the conditions of 120° C. and 35 kg-F/cm2 for two hours, then the mixed material can be cooled down naturally. Such that, a plurality of different ratios of raw films can be made for testing the infrared thermography and transmission of different composite materials.

1.2 Preparation of Millimeter-Wave Test Films: 3-mm carbon fiber is mixed with graphite, bamboo-charcoal and carbon black respectively in the ratio of 2:1, 1:1 and 1:2. Each group that is consist of the 3-mm carbon fiber with the graphite, the 3-mm carbon fiber with the bamboo-charcoal and the 3-mm carbon fiber with the carbon black mix with epoxy resin and curing agent respectively so as to obtain three groups of mixed materials, and make the concentrations of each groups of the mixed material in 0.0005 g/cm³, 0.001 g/cm³, 0.002 g/cm³, and 0.004 g/cm³. Thus the materials are put into the DC mixer for mixing one hour in order to completely mixing the materials. The mixed materials are moved into a steel mold with the dimensions of 15.2 cm×15.2 cm×2 mm (=46.2 cm³). Each mixed material is compressed by an electrothermal compression forming machine and under the conditions of 60° C. and 35 kg-F/cm2 for four hours, then the mixed material can be cooled down naturally. Such that, a plurality of different ratios of raw films can be made for testing the reflection loss values of different composite materials.

2.1 Analysis of Infrared Thermography: The black body of M305 of MIKRON Infrared Inc. in the United States of American is set a temperature that is 800° C. to be as a radiation source of infrared transmission. The detectors are an MWIR thermal imager (3-5 μm) and an FIR thermal imager (8-12 μm). The distance between the black body and the testing instruments is 1.5 m. Different concentrations of raw films may then be disposed on a base that is in front of the black body and with a distance of 1 m so as to test the temperature variations of the infrared thermography of the raw films.

2.2 Experiment of Infrared Transmission Analyzing: The experiment of analyzing infrared transmission employs polyethylene as a medium to be instead of a smoke screen in lab. To mix the medium doped the 3-mm carbon fiber with the graphite, bamboo-charcoal, and carbon black to produce different concentrations of raw films, each raw film is with the thickness of 1 mm. The black body is a radiation source for the experiment of analyzing infrared transmission. The temperature of the black body is set as 1000° C., and the detector is an infrared spectrometer and disposed 6 meters from the black body for scanning 30 times with the waveband range of 3 to 12 μm. The film is disposed on a base that is in front of the black body and with a distance of 1 m, so as to detect the average transmissions of the different concentrations of the raw films to infrared wave, and the average transmission is presented as below equation:

$${T}_{AVE} = \frac{S - {S}_{B}}{PE - {PE}_{B}} ,$$

where T_{AVE} is the average transmission, S is the energy of the radiation source passing through the raw materials, S_{B} is the background energy of the raw film, PE is the energy of the radiation source passing through pure polyethylene, and PE_{B} is the background energy of the radiation source passing through a pure polyethylene film.

2.3 The Test of Millimeter-Wave Reflection Loss: An electromagnetic wave reflection loss measuring system is operated for detection, and the scanning frequency range may be between 33.5 to 36.5 GHz. The measuring method via a microwave network analyzer is firstly to calibrate horizontal positions among test equipment and a tested object and then dispose a metal piece as the tested object with the dimensions same as 15 cm×15 cm of a specimen, more, the original reflection amount of the incident angle of an antenna is adjusted as well, then having another specimen can obtain the decay amount of reflection.

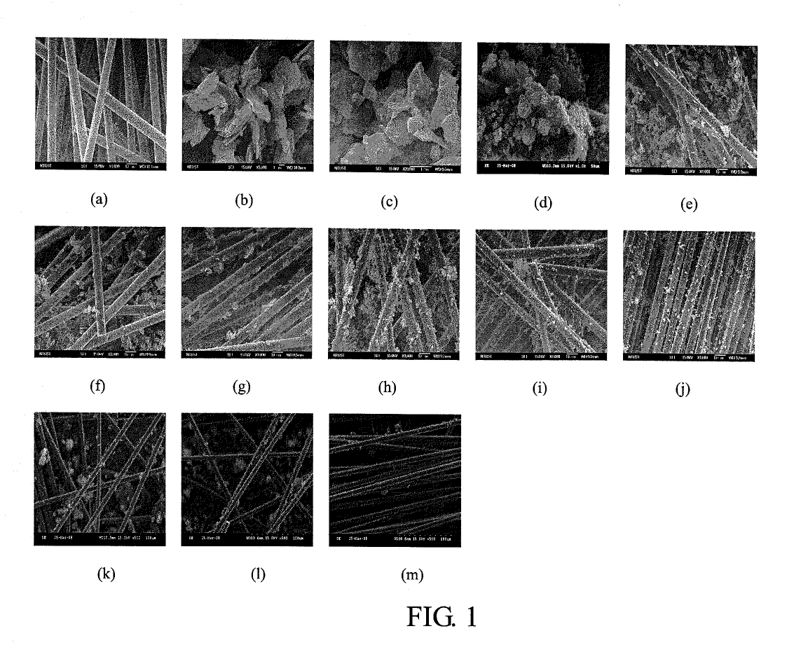

3.1 The Analysis of Scanning Electron Microscope (SEM): With references to FIG. 1a to 1m, which are illustrated by an SEM, the 3-mm carbon fiber in FIG. 1a is immersed in acetone and then dried by heat. The diameter of the carbon fiber is about 7.6 μm and the carbon fiber is disorder and purified after drying. That is, the carbon fiber can be decontaminated effectively for continuous steps. FIG. 1b is the SEM figure of graphite. The graphite is laminated without holes or bores. FIG. 1c is the SEM figure of bamboo-charcoal. The powder of bamboo-charcoal is shaped as an irregular particle, which surface is more smooth and has a plurality of holes or bores structure. FIG. 1d is the SEM figure of carbon black. The particle of the carbon black is defined by nanoscale in the aspect of dimensions thereof, and hence agglomeration is happening.

FIG. 1e to FIG. 1g are the SEM figures of mixing the graphite and 3-mm carbon fiber according to the ratios of 2:1, 1:1 and 1:2. Since the thickness of the graphite is fairly larger than each groove of the carbon fiber, the graphite hardly attaches onto the surface of the carbon fiber. With the lower ratio of the graphite and the carbon fiber, the amount of the graphite attaching onto the carbon fiber may be less. FIG. 1h to FIG. 1j are the SEM figures of mixing the bamboo-charcoal and 3-mm carbon fiber according to the ratios of 2:1, 1:1 and 1:2. Since the particle of the powder of the bamboo-charcoal is smaller, the bamboo-charcoal is thus easier to attach onto the surface of the carbon fiber. With the lower ratio of the bamboo-charcoal and the carbon fiber, the amount of the bamboo-charcoal attaching onto the carbon fiber may be less. FIG. 1k to FIG. 1m are the SEM figures of mixing the carbon black and 3-mm carbon fiber according to the ratios of 2:1, 1:1 and 1:2. Since the carbon black happens agglomeration, so that the carbon black is more hardly to attach onto the surface of the carbon fiber. With the lower ratio of the carbon black and the carbon fiber, the amount of the carbon black attaching onto the carbon may be less.

3.2 Analysis of Conductivity Test: σ=(1/R)×(h/A), σ represents a conductivity, the unit of the conductivity is S/cm, R represents the value of a resistor, the unit of the resistor is Ω, h an A represent a thickness and an area respectively and have the units of cm and cm². Table 1 shown as below is to analyze the conductivities of the ingots of mixing the graphite, the bamboo-charcoal and the carbon black with the 3-mm carbon fiber. Table 1 also shows the conductivities of pure materials, which are that graphite is 0.92 S/cm, carbon black is 0.19 S/cm, carbon fiber is 0.11 S/cm, and bamb00-xharcoal is 0.01 S/cm, obviously the conductivity of the graphite is the best, the carbon black's is the second, the carbon fiber's is the third, and the bamboo-charcoal's is the last. But, with the increasing ratio of the graphite doping into the carbon fiber, the conductivity may be increased as well. That is, GR/CF(2:1) is the value of 0.88 S/cm, GR/CF(1:1) is the value of 0.52 S/cm, and GR/CF(1:2) is the value of 0.29 S/cm, and thus GR/CF(2:1) is higher than GR/CF(1:1) and GR/CF(1:2), and GR/CF(1:1) is higher than GR/CF(1:2). With the increasing ratio of the carbon black doping into the carbon fiber, the conductivity may be increased as well. That is, CB/CF(2:1) is the value of 0.182 S/cm. CB/CF(1:1) is the value of 0.177 S/cm. CB/CF(1:2) is the value of 0.127 S/cm, and thus CB/CF(2:1) is higher than CB/CF(1:1) and CB/CF(1:2), and CB/CF(1:1) is higher than CB/CF(1:2). The only exception is that with the increasing ratio of bamboo-charcoal doping into the carbon fiber, the conductivity is lowered down. That is, BC/CF(2:1) is the value of 0.005 S/cm, BC/CF(1:1) is the value of 0.014 S/cm, and BC/CF(1:2) is the value of 0.035 S/cm, and thus BC/CF(2:1) is lower than BC/CF(1:1) and BC/CF(1:2), and BC/CF(1:1) is lower than BC/CF(1:2). Hence, as a conclusion, the conductivity of the bamboo-charcoal is lower than the carbon fiber.

TABLE 1
Analysis of the conductivities of the ingots of mixing
the graphite, the bamboo-charcoal and the carbon
black with the 3-mm carbon fiber

| | Con- | | Con- | | |
|---|---|---|---|---|---|
| | ductivity | | ductivity | | Conductivity |
| Specimen | (S/cm) | Specimen | (S/cm) | Specimen | (S/cm) |
| PVA | 0.0193 | PVA | 0.0193 | PVA | 0.0193 |
| 3 mm CF | 0.1143 | 3 mm CF | 0.1143 | 3 mm CF | 0.1143 |
| GR | 0.9181 | BC | 0.0097 | CB | 0.1887 |
| GR/CF2:1 | 0.8846 | BC/CF2:1 | 0.0052 | CB/CF2:1 | 0.1820 |
| GR/CF1:1 | 0.5215 | BC/CF1:1 | 0.0144 | CB/CF1:1 | 0.1769 |
| GR/CF1:2 | 0.2897 | BC/CF1:2 | 0.0348 | CB/CF1:2 | 0.1274 |

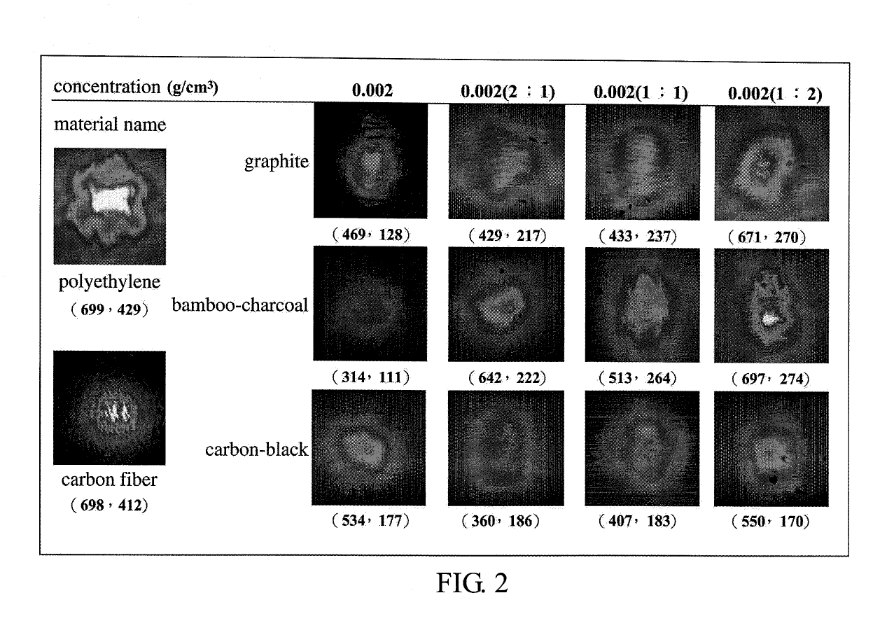

3.3 Analysis of Infrared Thermography Test: With reference to FIG. 2, which illustrates temperature variations of the mid infrared (3 to 5 μm) thermographies of the composite films of the graphite, bamboo-charcoal and carbon black respectively mixing with the 3-mm carbon fiber/polyethylene film. The highest and average temperatures of the pure polyethylene film are 699° C. and 429° C. The highest and average temperatures of the pure 3-mm carbon fiber film are 698° C. and 412° C. The highest and average temperatures of the pure graphite film are 469° C. and 128° C. The highest and average temperatures of the pure bamboo-charcoal film are 314° C. and 111° C. The highest and average temperatures of the pure carbon black film are 534° C. and 177° C. As a conclusion, the shading effect of the pure bamboo-charcoal film to the mid infrared thermography is better than others. The temperature variations of the mid infrared thermographies of the composite films of mixing the graphite, bamboo-charcoal and carbon black with the 3-mm carbon fiber and polyethylene represent that the shading effect of the composite film of mixing the carbon black with the 3-mm carbon fiber and polyethylene is better, and the average thermography temperature of the composite film of mixing the carbon black with the 3-mm carbon fiber and polyethylene is lowered from 429° C. to 180° C. Namely, the infrared energy is transformed to free electron motion energy so as to lower the temperature for achieving the infrared shading effect.

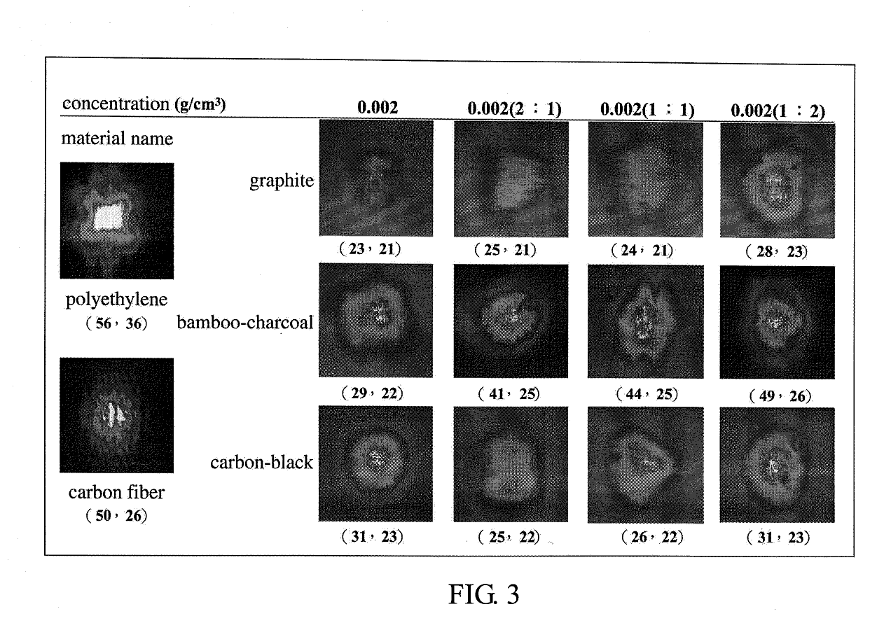

With reference to FIG. 3, which illustrates temperature variations of the far infrared (8 to 12 μm) thermographies of the composite films of the graphite, bamboo-charcoal and carbon black respectively mixing with the 3-mm carbon fiber/polyethylene film. The highest and average temperatures of the pure polyethylene film are 56° C. and 36° C. The highest and average temperatures of the pure 3-mm carbon fiber film are 50° C. and 26° C. The highest and average temperatures of the pure graphite film are 23° C. and 21° C. The highest and average temperatures of the pure bamboo-charcoal film are 29° C. and 22° C. The highest and average temperatures of the pure carbon black film are 31° C. and 23° C. As a conclusion, the shading effect of the pure graphite film to the far infrared thermography is better than others. The temperature variations of the far infrared thermographies of the composite films of mixing the graphite, bamboo-charcoal and carbon black with the 3-mm carbon fiber and polyethylene represent that the shading effect of the composite film of mixing the graphite with the 3-mm carbon fiber and polyethylene is better, and the average thermography temperature of the composite film of mixing the graphite with the 3-mm carbon fiber and polyethylene is lowered from 36° C. to 21° C.

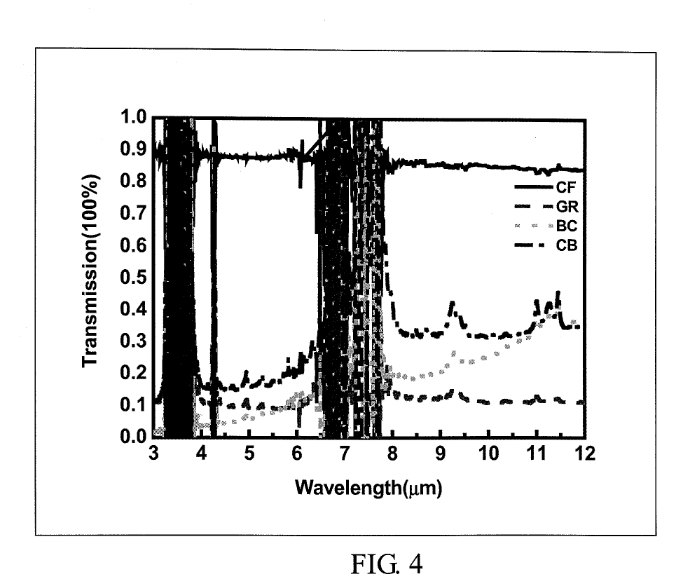

3.4 Analysis of Testing Infrared Transmission: With reference to FIG. 4, which illustrates a comparison chart of the infrared transmissions of the 3-mm carbon fiber, graphite, bamboo-charcoal, and carbon black under the same concentration (0.002 g/cm³). The result shows that the graphite is the best, the bamboo-charcoal is the second, the carbon black is the third, and the carbon fiber is the last. That is, the low transmission of the graphite is the best than other material, and the high transmission of the carbon fiber is the worst than other material. The result is just matches with above analyzed results of the infrared thermographies. In other words, the graphite, bamboo-charcoal and carbon black can achieve an excellent infrared shading effect so as to be infrared shading materials.

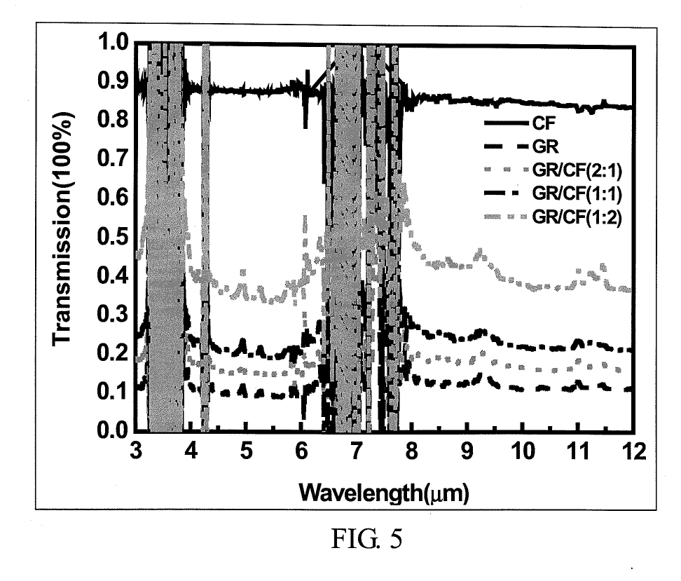

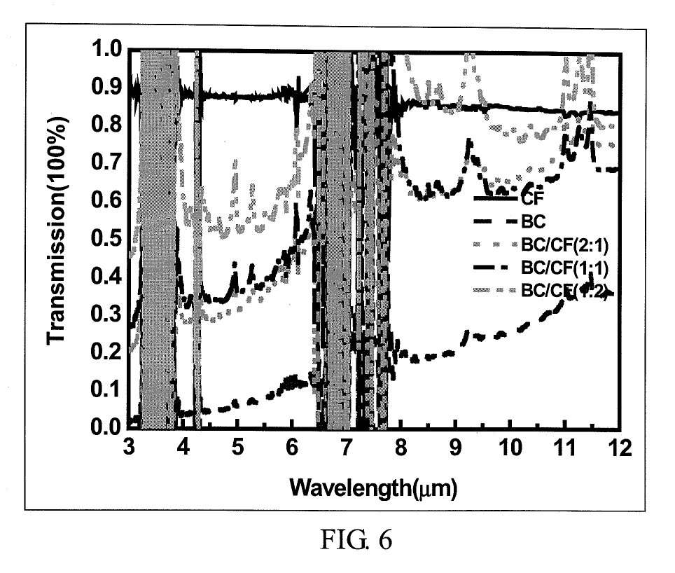

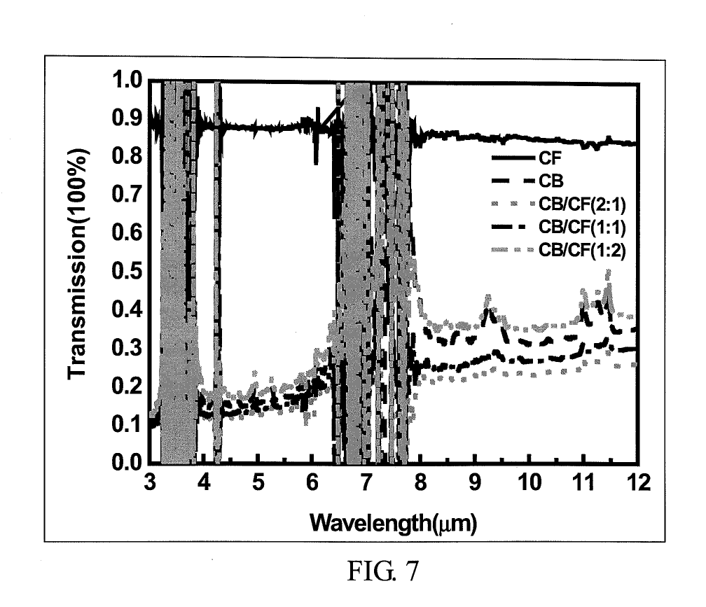

With references to FIG. 5 to FIG. 7, which illustrate three comparison charts of the infrared transmissions of the composite films of the graphite, bamboo-charcoal and carbon black respectively mixing with the 3-mm carbon fiber/polyethylene films according to different ratios. The result shows that the infrared transmissions of the composite films of the graphite, bamboo-charcoal and carbon black respectively mixing with the 3-mm carbon fiber/polyethylene film are fairly lower than the infrared transmission of the pure 3-mm carbon fiber film, but a little higher than the infrared transmissions of the pure graphite film, pure bamboo-charcoal film and pure carbon black film. With the increasing ratios of the graphite, bamboo-charcoal and carbon black respectively, each infrared transmission may be lowered down gradually. The result appears that the graphite-carbon fiber film and the carbon black-carbon fiber film both have excellent infrared shading effects except the bamboo-charcoal-carbon fiber, which infrared transmission is higher than others. The possible reason is that under the same concentration, the particle of the bamboo-charcoal is larger so that the distribution area of the bamboo-charcoal is smaller, and the irregular shape and the thicker thickness of the edge of each particle of the bamboo-charcoal cause worse reflection and scattering of the infrared wave and weaken the shading effect.

3.5 Analysis of Millimeter-Wave Reflection Loss Test: The pure epoxy resin absorbing film has only −1 dB reflection loss. Therefore it proves that the epoxy resin may not achieve the absorbing effect of millimeter-wave (35 GHz). But after adding the carbon fiber, the 3-mm carbon fiber has the reflection loss of −10 dB while the concentration of the 3-mm carbon fiber is between 0.0005 g/cm³-0.002 g/cm³, and the 3-mm carbon fiber has the best reflection loss of −14 dB while the concentration of the 3-mm carbon fiber is 0.001 g/cm³. More, while the concentration of the carbon fiber increases or decreases gradually, on the contrary, the dB value is decreased. From above, a conclusion is proved that the 3-mm carbon fiber can achieve a better absorbing effect (−14 dB) for the 35 GHz (8 mm) millimeter-wave, and it conform to the theory of half-wave dipole. Therefore, the 3-mm carbon fiber can be a smoke screening material to interfere the 8-mm wave at 35 GHz with the experimental result that 95% absorbing effect is approached, and also achieves the shading effect.

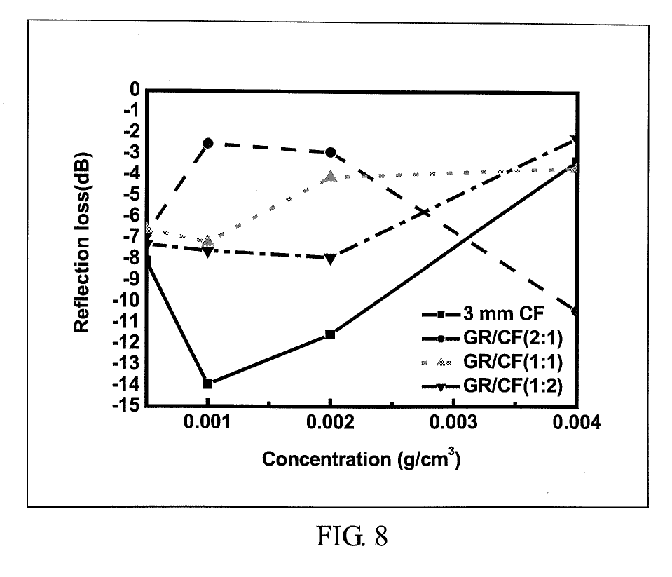

With reference to FIG. 8, which illustrates a chart of the reflection losses at 35 GHz of the absorbing film of mixing the graphite with the 3-mm carbon fiber according to different ratios and concentrations. The absorbing film mixed with graphite and carbon fiber in the ratio 2:1 can achieve the best reflection loss of −10 dB under the concentration of 0.004 g/cm³. The absorbing film mixed with graphite and carbon fiber in the ratio 1:1 can achieve the best reflection loss of −7 dB under the concentration of 0.001 g/cm³. The absorbing film mixed with graphite and carbon fiber in the ratio 1:2 can achieve the best reflection loss of −8 dB under the concentration of 0.002 g/cm³.

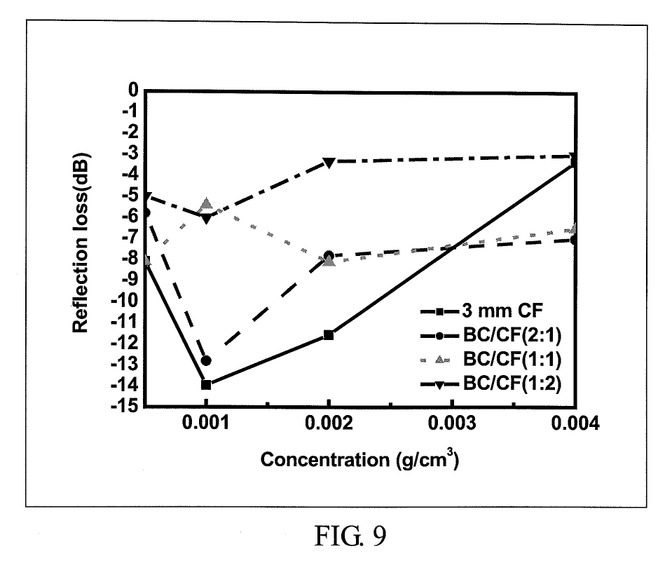

With reference to FIG. 9, which illustrates a chart of the reflection losses at 35 GHz of the absorbing film of mixing the bamboo-charcoal with the 3-mm carbon fiber according to different ratios and concentrations. The absorbing film mixed with bamboo-charcoal and carbon fiber in the ratio 2:1 can achieve the best reflection loss of −13 dB under the concentration of 0.001 g/cm³. The absorbing film mixed with bamboo-charcoal and carbon fiber in the ratio 1:1 can achieve the best reflection loss of −8 dB under the concentrations of 0.005 and 0.002 g/cm³. The absorbing film mixed with bamboo-charcoal and carbon fiber in the ratio 1:2 can achieve the best reflection loss of −6 dB under the concentration of 0.001 g/cm³.

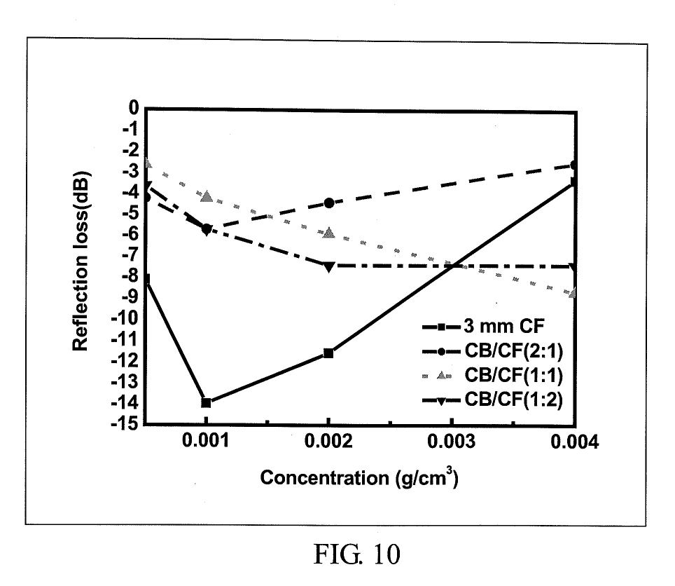

With reference to FIG. 10, which illustrates a chart of the reflection losses at 35 GHz of the absorbing film of mixing the is carbon black with the 3-mm carbon fiber according to different ratios and concentrations. The absorbing film mixed with carbon black and carbon fiber in the ratio 2:1 can achieve the best reflection loss of −6 dB under the concentration of 0.001 g/cm³. The absorbing film mixed with carbon black and carbon fiber in the ratio 1:1 can achieve the best reflection loss of −9 dB under the concentration of 0.004 g/cm³. The absorbing film mixed with carbon black and carbon fiber in the ratio 1:2 can achieve the best reflection loss of −7 dB under the concentrations of 0.002 and 0.004 g/cm³.

What is claimed is:

1. A method for manufacturing a material with a multispectral smoke screening comprising the steps of:
(1) mixing graphite and 3-mm carbon fiber with the ratio of 2:1;
(2) mixing material of step (1) with polyethylene (PE) so as to make the concentration of the material in the range of 0.002 to 0.02 g/cm³;
(3) fully mixing the material made in step (2) for a period of time; and;
(4) moving the material made in step (3) into a steel mold for being molded by thermal pressure for a period of time, and then such material being naturally cooled down to form a plastic piece.

2. The method for manufacturing the material with the multispectral smoke screening according to claim 1, wherein the best mixing time period to fully mix the material made in the step (2) by a DC stirrer is two hours.

3. The method for manufacturing the material with the multispectral smoke screening according to claim 1, wherein the material molded by the thermal pressure and being naturally cooled down for a period of time of the step (4) is performed by an electrothermal compression forming machine for two hours under pressure 35 kg-F/cm² and temperature 120° C., and then cooled down naturally.

4. A method for manufacturing a material with a multispectral smoke screening comprising the steps of:
(1) mixing graphite and 3-mm carbon fiber with the ratio of 2:1;
(2) mixing material of step (1) with epoxy resin and curing agent so as to make the material in the concentration of the range between 0.0005 to 0.004 g/cm³;
(3) fully mixing the material made in step (2) for a period of time; and
(4) moving the material made in step (3) into a steel mold for being molded by thermal pressure for a period of time to form a plastic piece.

5. The method for manufacturing the material with the multispectral smoke screening according to claim 4, wherein the best mixing time period to fully mix the material made in the step (2) by a DC stirrer is one hours.

6. The method for manufacturing the material with the multispectral smoke screening according to claim 4, wherein the material molded by thermal pressure for a period of time of the step (4) is performed by an electrothermal compression forming machine for our hour under pressure 35 kg-F/cm2 and temperature 60° C.
